(19) United States
(12) Patent Application Publication
(10) Pub. No.: US 2006/0182007 A1
(43) Pub. Date: Aug. 17, 2006

(54) Realizing high quality LPCM audio data as two separate elementary streams

(76) Inventor: David Konetski, Austin, TX (US)

Correspondence Address: HAMILTON & TERRILE, LLP, P.O. BOX 203518, AUSTIN, TX, 78720, US

(21) Appl. No.: 11/056,637

(22) Filed: Feb. 11, 2005

(51) Int. Cl. G11B 7/24

(52) U.S. Cl. 369/275.1

(57) ABSTRACT

A method and apparatus for providing high definition audio formats in a minimum file size while providing compatibility for media players capable of decoding only lower quality audio files. In an embodiment of the invention, a linear pulse code modulation (LPCM) 192/24 data stream is split into two elementary data streams. The primary data stream is in LPCM 96/24 (96 KHz sampling rate and 24 bit sample size) format, which can be rendered by all media players capable of decoding advanced entertainment formats. The secondary data stream is comprised of additional bits required for support of the LPCM 192/24 format. Media players capable of only reading LPCM 96/24 format can operate by rendering the primary data stream in its native format. Players capable of reading the LPCM 192/24 format combine the primary and secondary data streams to create a composite LPCM 192/24 data stream for rendering. The combined size of resulting primary and secondary data stream files is less than the file size created by current implementations of LPCM 192/24 supporting a separate mandatory audio stream of LPCM 96/24. Using the method and apparatus of the invention, high definition audio formats can be supported with reduced file sizes, and base-level media players will be able to render the highest quality audio format they are capable of supporting.

### BACKGROUND OF THE INVENTION

1. Field of the Invention

The present invention relates in general to the field of digital recording and, more particularly, to authoring digital audio content to support two or more audio formats of differing quality.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is processed, stored or communicated, and how quickly and efficiently the information may be processed, stored, or communicated. The variations in information handling systems allow for information handling systems to be general or configured for a specific user or specific use such as financial transaction processing, airline reservation, enterprise data storage, or global communications. In addition, information handling systems may include a variety of hardware and software components that may be configured to process, store, and communicate information, and may include one or more computer systems, data storage systems, and networking systems. Information handling systems continually improve in the ability of both hardware components and software applications to generate and manage information.

One of the fast growing applications for the use of information handling systems is in the field of audio-visual systems, particularly those related to high definition television (HDTV). With the growing popularity of HDTV, consumer demand for prerecorded, high definition video and audio content is increasing rapidly. The need to match audio quality to high definition video has led to the development of new digital audio authoring formats using technologies such as linear pulse code modulation (LPCM) with a 192 KHz sampling rate and a 24 bit sample size, hereinafter referred to as LPCM 192/24.

Authoring audio content in the LPCM 192/24 high definition format creates very large data files, especially when multiple channels are encoded. The need to accommodate these large file sizes has led to the development of higher capacity formats such as “high-definition” DVD (HD-DVD) and “Blu-Ray,” both of which use a blue laser for reading and writing digital content. The original DVD capacity was limited to 4.7 GB in single layer format, and 8.4 GB in double layer format. HD-DVDs have a capacity of 15 GB per layer while Blu-Ray is able to deliver 25 GB per layer. In dual layer versions, the two formats can provide 30 GB and 50 GB of capacity, respectively. These higher capacity media would appear to offer a solution to accommodate the requisite large file sizes inherent with high definition video and audio content.

However, base-level digital media players, and new players using older digital to analog converters (DACs) and less capable digital processors, are unable to interpret LPCM 192/24 content in its native mode. To make content distributed in LPCM 192/24 format backward compatible, mandatory support of a second audio track in a standard digital audio format is required. New disc formats specify LPCM 96/24, Dolby Digital (AC-3), or DTS (Digital Theater System) 5.1 for the mandatory second audio track which, under current implementations, is included in addition to the LPCM 192/24 bitstream.

Under current implementations of new disc formats, the mandatory secondary audio track can be recognized by base-level media players and extracted for processing. LPCM 96/24, with its 96 KHz sampling rate and 24 bit sample size, is the preferred format for the mandatory secondary audio stream, as it provides the highest audio quality after LPCM 192/24 and is readable by all base level players. Dolby Digital and DTS (Digital Theater System) 5.1 provide lesser quality, as they are encoded at 48 KHz/16 bit and 48 KHz/20 bit, respectively, and are lossy compression standards.

Current implementations for including both LPCM 96/24 and LPCM 192/24 bitstreams create disproportionately large file sizes. These large files, when combined with high definition video content, can result in combined file sizes that exceed disc capacities. As an example, LPCM 192/24 audio format for six channels (left, center, right, left rear, right rear, and low frequency) requires 27 Mbps. Highly compressed high definition video requires 6 Mbps. Supporting the mandatory secondary audio channel under current implementations at 96 KHz and 24 bits requires an additional 14.4 Mbps, resulting in a total requirement of 47.4 Mbps. A 25 GB Blu-Ray DVD is only capable of supporting 70 minutes of content at this combined bitstream rate.

At present, the most common solution is for content authors to embed a lower quality mandatory audio stream (e.g., Dolby digital or DTS), which reduces the post-authoring audio file size to assist in fitting all required content within the capacity limits of the disc. While this approach supports the LPCM 192/24 requirement to support a mandatory, secondary audio format, it limits the audio quality available to owners of media players that may be able to decode higher quality mandatory audio formats (e.g., LPCM 96/24), but not LPCM 192/24.

In view of the foregoing, there is a need for a system for providing higher quality audio formats (e.g., LPCM 96/24) to owners of base-level media players while still providing LPCM 192/24 files without exceeding the capacity of the media.

### SUMMARY OF THE INVENTION

The present invention overcomes the inadequacies of prior art by providing a method and apparatus that enables an LPCM 192/24 bitstream to be split into two elementary streams. In one embodiment of the invention, the primary bitstream is in LPCM 96/24 (96 KHz sampling rate and 24 bit sample size) format, which can be rendered by media players as a mandatory audio format. The secondary bitstream is comprised of additional bits required for support of the LPCM 192/24 format. Media players capable of only rendering LPCM 96/24 format can operate by rendering the primary bitstream in its native format. Players capable of rendering the LPCM 192/24 format combine the primary and secondary bitstreams to create a composite LPCM 192/24 bitstream for rendering. The combined size of resulting primary and secondary bitstream files is less than the file size created by current implementations of LPCM 192/24 supporting a secondary audio stream of LPCM 96/24. Using the method and apparatus of the present invention, high definition audio formats can be supported with reduced file sizes, and base-level media players will be able to render the highest quality audio format they are capable of supporting.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a generalized illustration of an information handling system that can be used to implement the method and apparatus of the present invention.

FIG. 2 is a generalized illustration of a method and apparatus for authoring audio content into a dual stream LPCM 192/24 format.

FIG. 3 is a more detailed illustration of how the present invention splits an original LPCM 192/24 bitstream into two resulting bitstreams.

FIG. 4 illustrates another embodiment of the invention that results in slightly lower fidelity.

### DETAILED DESCRIPTION

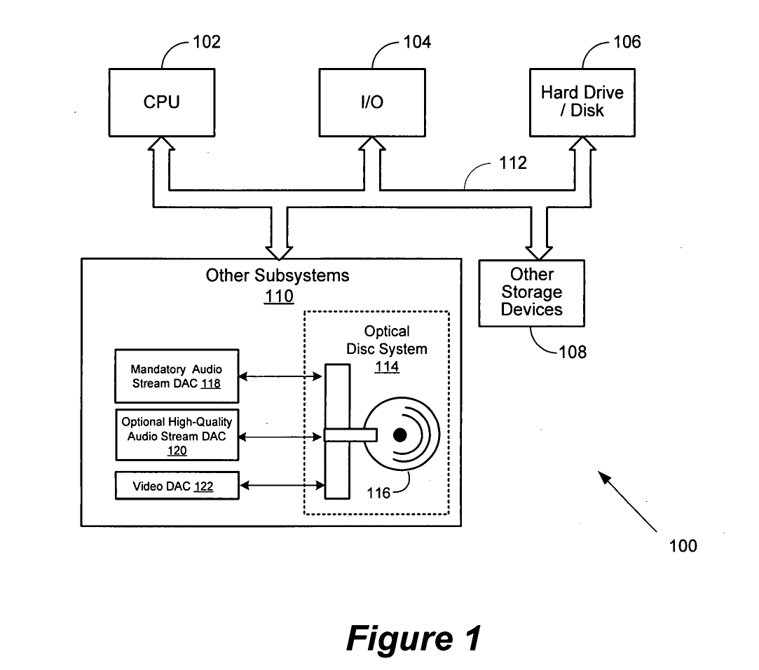

FIG. 1 is a generalized illustration of an information handling system 100 that can be used to implement the method and apparatus of the present invention. The information handling system includes a processor 102, input/output (I/O) devices 104, such as a display, a keyboard, a mouse, and associated controllers, a hard disk drive 106 and other storage devices 108, such as a floppy drive and other memory devices, and various other subsystems 110, all interconnected via one or more buses 112. In an embodiment of the present invention, the subsystems 110 include an optical disc system 114, comprising a disc 116 that contains data for generating a plurality of data streams that can be processed to generate high-quality audio signals, as discussed in greater detail herein below. As will be discussed in greater detail hereinbelow, one of the bitstreams is in a mandatory, backward-compatible format that is processed by digital-to-analog (DAC) converter 118, while the other bitstream is in an optional higher-quality format that can be processed by DAC 120. Video data bitstreams from the disc 116 are processed by video DAC 122.

For purposes of this disclosure, an information handling system may include any instrumentality or aggregate of instrumentalities operable to compute, classify, process, transmit, receive, retrieve, originate, store, display, manifest, detect, record, reproduce, handle, or utilize any form of information, intelligence or data for business, scientific, control or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, read only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

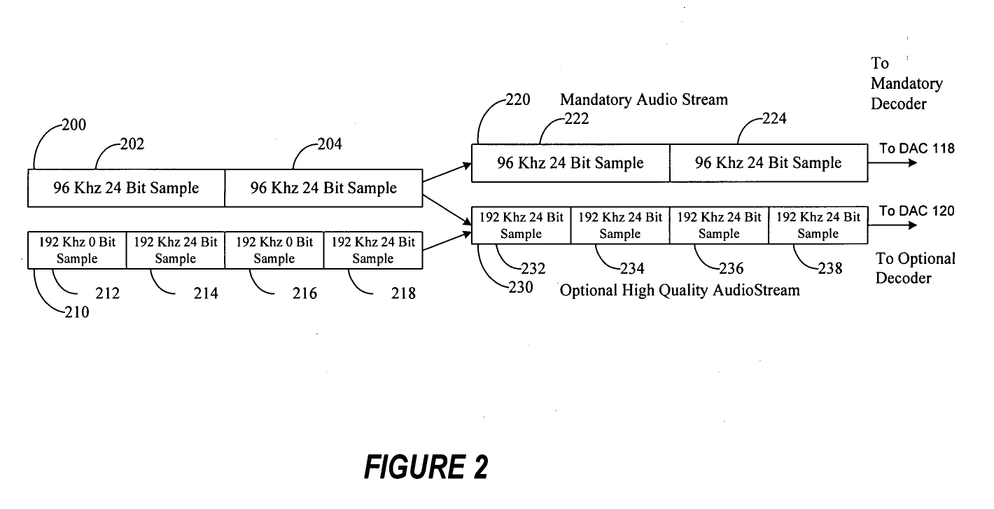

FIG. 2 is a generalized illustration of a data structure that is implemented in the method and apparatus for authoring audio content into a dual stream LPCM 192/24 format. In various embodiments of the invention, the data format illustrated in FIG. 2 is capable of supporting a high quality (e.g., LPCM 96/24) mandatory audio format, but consumes less storage space than current implementations of LPCM 192/24 with the same quality mandatory secondary audio format.

During the digital audio authoring process, two bitstreams, 200 and 210, are produced from the same audio content. In one embodiment of the invention, bitstream 200 is one of the mandatory audio formats required to be supported and is comprised of sequential (and ongoing) frames 202, 204 of audio content sampled at 96 KHz and written as 24 bit words. Bitstream 210 is comprised of sequential (and ongoing) frames 212, 214, 216, 218 sampled at 192 KHz. However, alternating (and ongoing) frames 212, 216 are written as 0 bit length words and alternating (and ongoing) frames 214, 218 are written as 24 bit length words.

In this embodiment, a media player capable of rendering only LPCM 96/24 format recognizes the LPCM 96/24 bitstream 220, comprised of sequential (and ongoing) frames 222, 224 that are decoded by a mandatory format DAC 118 shown in FIG. 1. In this embodiment, a media player capable of rendering LPCM 192/24 format combines bitstreams 200 and 210 in real-time into a single bitstream 230, comprised of sequential (and ongoing) 192 KHz-24 bit frames 232, 234, 236, 238, which are then rendered by the optional high quality DAC 120 shown in FIG. 1.

The present invention, as discussed in greater detail hereinbelow, can support a plurality of audio formats to generate the mandatory, primary audio stream with a significant reduction in the size of post-authoring file sizes compared to current implementations of the optional LPCM 192/24 format. Those skilled in the art will recognize that the invention is equally applicable to reducing the bandwidth required to transport audio files for network delivery.

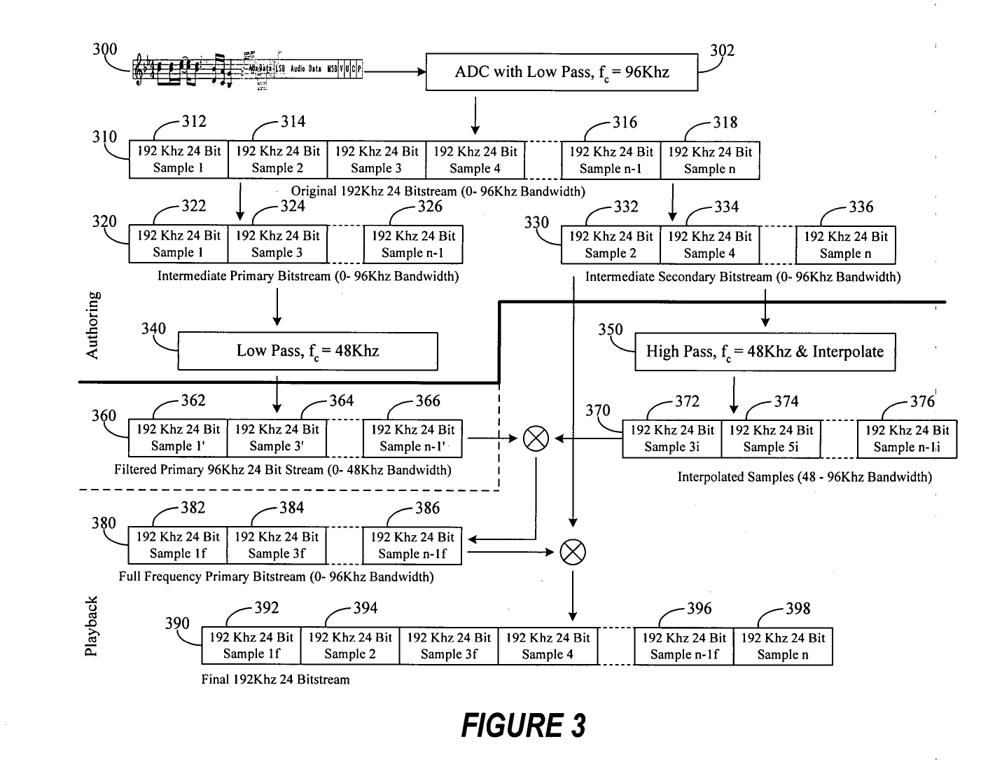

FIG. 3 is a more detailed illustration of how the present invention splits an original LPCM 192/24 bitstream into two resulting bitstreams. To maintain synchronicity, sample to sample, between the primary and secondary audio streams, audio content 300 must first be authored as an original LPCM 192/24 bitstream 310. In one embodiment of the invention, authoring of the original LPCM 192/24 bitstream 310 uses an analog to digital converter (ADC) 302 with a low pass, anti-alias cut-off filter (f_{c}) of 96 KHz. The original LPCM 192/24 bitstream 310 is comprised of “n” number of sequential 192 KHz-24 bit frames. Half of the frames are designated as “odd,” beginning with the first frame 312 and continuing on to the next-to-last frame 316, which is referenced as frame number “n−1.” The other half of the LPCM 192/24 frames 330 are designated as “even,” beginning with the second frame 314 and continuing on to the last frame 318, which is referenced as frame number “n.”

In one embodiment of the invention, an intermediate, primary 96 KHz-24 bit audio bitstream 320 is extracted out of the original LPCM 192/24 bitstream 310 to satisfy the mandatory audio format requirement. The intermediate, primary 96 KHz-24 bit audio bitstream 320 is generated by odd-numbered samples 322, 324 and continuing on to the last odd sample 326, referenced by frame “n−1,” of the original LPCM 192/24 bitstream 310. The resultant intermediate, primary 96 KHz-24 bit audio bitstream 320 is then fed through a low pass frequency filter 340 with an (f_{c}) of 48 KHz for anti-aliasing. The filtered 96 KHz-24 bit audio bitstream 360 is rendered from the filtered frames 362, 364 and continuing on to the last filtered frame 326, referenced as “n−1f.”

A second intermediate bitstream 330 is constructed of the remaining, even numbered frames 332, 334 and continuing on to 336, referenced as frame number “n.” This second intermediate bitstream 330 is used to create a final 192/24 bitstream 390 through additional processing steps described hereinbelow.

The filtered 96 KHz-24 bit audio bitstream 360 is created with a low pass frequency filter 340 with an (f_{c}) of 48 KHz, resulting in even numbered frames containing low frequency information. The second intermediate bitstream 330 has an (f_{c}) of 96 KHz, which is passed through a high pass frequency filter 350, which is used in combination with an interpolation process to create bitstream 370 constructed from odd numbered frames 372, 374 and continuing on to 376, referenced as frame “n−1i,” that carry high frequency audio data.

The interpolated samples bitstream 370, containing odd samples with high frequency audio data, can be combined with the filtered 96 KHz-24 bit audio bitstream 360, to create a full frequency, mandatory bitstream 380 comprised of full frequency frames 382, 384 and continuing on to the last filtered frame 386, referenced as “n−1f.” This full frequency, primary bitstream 380 can be rendered by a media player capable of decoding the LPCM 96/24 format. The full frequency, primary bitstream 380 can also be combined with the intermediate secondary bitstream 330 to create a final, full frequency LPCM 192/24 bitstream 390, comprised of full frequency, odd frames 392 continuing on to the last odd frame 396, referenced as “n−1,” and full frequency, even frames 394 continuing on to the last even frame 398, referenced as “n.” The final, full frequency LPCM 192/24 bitstream 390 can then be rendered by any media player capable of decoding the LPCM 192/24 format.

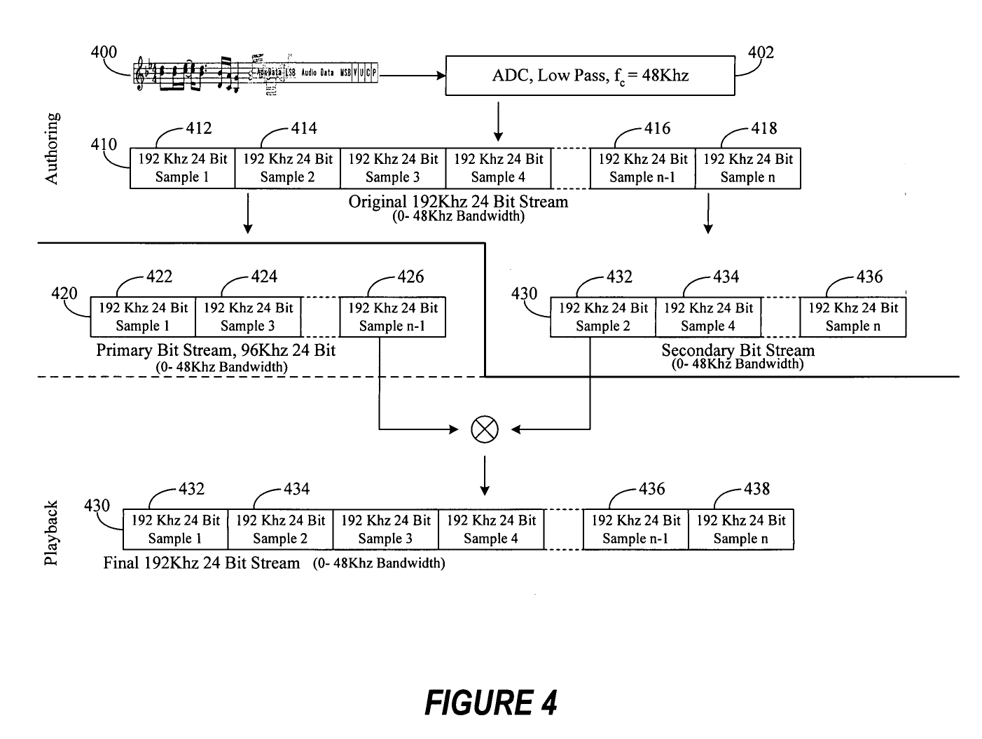

FIG. 4 illustrates another embodiment of the invention that results in slightly lower frequency range than is normally realized from 192 KHz sampling rates, but retains the advantage of lower noise due to the higher sampling frequency. To maintain synchronicity, sample to sample, between the primary and secondary audio streams, audio content 400 must first be authored as an original LPCM 192/24 bitstream 410. In one embodiment of the invention, authoring of the original LPCM 192/24 bitstream 410 uses an analog to digital converter (ADC) 402 with a low pass, anti-alias cut-off filter (f_{c}) of 48 KHz. The original LPCM 192/24 bitstream 410 is comprised of “n” number of sequential 192 KHz-24 bit frames. Half of the frames are designated as “odd,” beginning with the first frame 412 and continuing on to the next-to-last frame 416, which is referenced as frame number “n−1.” The other half of the LPCM 192/24 frames 430 are designated as “even,” beginning with the second frame 414 and continuing on to the last frame 418, which is referenced as frame number “n.”

In one embodiment of the invention, an intermediate, primary 96 KHz-24 bit audio bitstream 420 is extracted out of the original LPCM 192/24 bitstream 410 to satisfy the requirement to provide a mandatory audio format. The intermediate, primary 96 KHz-24 bit audio bitstream 420 is generated by odd-numbered samples 422, 424 and continuing on to the last odd sample 426, referenced by frame “n−1,” of the original LPCM 192/24 bitstream 410. A second intermediate 96 KHz-24 bit audio bitstream 430 is constructed of the remaining, even numbered frames 432, 434 and continuing on to 436, referenced as frame number “n.”

The intermediate, primary 96 KHz-24 bit audio bitstream 420 is combined with the second intermediate 96 KHz-24 bit audio bitstream 430 to create a final LPCM 192/24 bitstream 490 comprised of limited frequency, odd frames 432 continuing on to 436, the last odd frame, referenced as “n−1,” and limited frequency, even frames 434 continuing on to the last even frame 438, referenced as “n.” The final, LPCM 192/24 bitstream 430 can then be rendered by any media player capable of decoding the LPCM 192/24 format, but will not produce audio content with the full spectral components evident in current LPCM 192/24 implementations.

Use of the invention will insure, at a minimum, that a higher quality, mandatory audio format can be supported as part of a LPCM 192/24 implementation with reduced file sizes to accommodate distribution media capacity limitations. Further, media players not able to read audio content in LPCM 192/24 format will be able to render the same audio content in LPCM 96/24 format instead of a lesser quality audio format due to media capacity limitations.

Although the present invention has been described in detail, it should be understood that various changes, substitutions and alterations can be made hereto without departing from the spirit and scope of the invention as defined by the appended claims.

What is claimed is:

1. A method for generating audio signals using a storage medium, comprising:
storing data files on said storage medium, said data files comprising a digital representation of an original audio signal;
generating first and second elementary data streams from said data files;
using said first elementary data stream to generate a first audio signal at a first audio quality; and
using said second elementary data stream to generate a second audio signal at a second audio quality.

2. The method of claim 1, wherein said first elementary data stream comprises a 96 KHz/24 bit digital representation of said original audio signal.

3. The method of claim 1, wherein said second elementary data stream comprises additional data bits that are combined with said first elementary data stream to generate said second audio signal at said second audio quality.

4. The method of claim 3, wherein said second elementary data stream comprises a plurality of data frames containing data sampled at 192 KHz with alternating frames of said data stream being written as 0 bit length words and 24 bit words, respectively, with data in said frames containing 24 bit words being combined with data in said first elementary data stream to generate an audio signal comprising a plurality of 192 KHz/24 bit data frames.

5. The method of claim 1, wherein said first and second elementary data streams are authored by:
generating a 192 KHz/24 bit data stream corresponding to said original audio signal, said 192 KHz/24 bit signal comprising a plurality of successive odd and even 192 KHz/24 bit data frames;
using a 96 KHz filter to generate a plurality of successive odd and even filtered 192 KHz/24 bit data frames; and
using said successive odd frames to generate a 96 KHz/24 bit representation of said original audio signal.

6. The method of claim 1, wherein said plurality of successive odd 192 KHz/24 bit data frames used to generate said 96 KHz/24 bit representation of said original audio signal are filtered using a 48 KHz anti-aliasing filter.

7. The method of claim 6, wherein said plurality of successive even data frames are processed using interpolation and high pass filtering to generate a plurality of additional odd data frames comprising high frequency data.

8. The method of claim 7, wherein said additional odd data frames are combined with said plurality of filtered odd 192 KHz/24 bit data frames to generate a plurality of 192 KHz/24 bit odd data frames.

9. The method of claim 8, wherein said plurality of 192 KHz/24 bit odd data frames are combined with said plurality of 192 KHz/24 bit even data frames to generate a 192 KHz/24 bit audio signal.

10. The method of claim 4, wherein said first and second elementary data streams are authored by:
generating a 192 KHz/24 bit data stream corresponding to said original audio signal, said 192 KHz/24 bit signal comprising a plurality of successive odd and even 192 KHz/24 bit data frames;
using a 48 KHz filter to generate a plurality of successive odd and even 192 KHz/24 bit data frames; and
using said successive odd frames to generate a 96 KHz/24 bit representation of said original audio signal.

11. The method of claim 10, wherein said plurality of odd and even frames are combined to generate a 192 KHz/24 bit audio signal.

12. An information handling system for generating an audio signal, comprising:
a data storage medium operable to store data files comprising a digital representation of an original audio signal; and
a processor operable to process said data files to:
generate first and second elementary data streams from said data files;
use said first elementary data stream to generate a first audio signal at a first audio quality; and
use said second elementary data stream to generate a second audio signal at a second audio quality.

13. The information handling system of claim 12, wherein said first elementary data stream comprises a 96 KHz/24 bit digital representation of said original audio signal.

14. The information handling system of claim 12, wherein said second elementary data stream comprises additional data bits that are combined with said first elementary data stream to generate said second audio signal at said second audio quality.

15. The information handling system of claim 14, wherein said second elementary data stream comprises a plurality of data frames containing data sampled at 192 KHz with alternating frames of said data stream being written as 0 bit length words and 24 bit words, respectively, with data in said frames containing 24 bit words being combined with data in said first elementary data stream to generate an audio signal comprising a plurality of 192 KHz/24 bit data frames.

16. The information handling system of claim 12, wherein said first and second elementary data streams are authored by:
generating a 192 KHz/24 bit data stream corresponding to said original audio signal, said 192 KHz/24 bit signal comprising a plurality of successive odd and even 192 KHz/24 bit data frames;
using a 96 KHz filter to generate a plurality of successive odd and even filtered 192 KHz/24 bit data frames; and
using said successive odd frames to generate a 96 KHz/24 bit representation of said original audio signal.

17. The information handling system of claim 12, wherein said plurality of successive odd 192 KHz/24 bit data frames used to generate said 96 KHz/24 bit representation of said original audio signal are filtered using a 48 KHz anti-aliasing filter.

18. The information handling system of claim 17, wherein said plurality of successive even data frames are processed using interpolation and high pass filtering to generate a plurality of additional odd data frames comprising high frequency data.

19. The information handling system of claim 18, wherein said additional odd data frames are combined with said plurality of filtered odd 192 KHz/24 bit data frames to generate a plurality of 192 KHz/24 bit odd data frames.

20. The information handling system of claim 19, wherein said plurality of 192 KHz/24 bit odd data frames are combined with said plurality of 192 KHz/24 bit even data frames to generate a 192 KHz/24 bit audio signal.

21. The information handling system of claim 15, wherein said first and second elementary data streams are authored by:
generating a 192 KHz/24 bit data stream corresponding to said original audio signal, said 192 KHz/24 bit signal comprising a plurality of successive odd and even 192 KHz/24 bit data frames;
using a 48 KHz filter to generate a plurality of successive odd and even 192 KHz/24 bit data frames; and
using said successive odd frames to generate a 96 KHz/24 bit representation of said original audio signal.

22. The information handling system of claim 21, wherein said plurality of odd and even frames are combined to generate a 192 KHz/24 bit audio signal.
